(19) United States
(12) Patent Application Publication
(10) Pub. No.: US 2015/0052980 A1
(43) Pub. Date: Feb. 26, 2015

(54) GAS TURBINE FUEL NOZZLE LEAK DETECTION PRESSURE TEST TOOL AND METHOD FOR LEAK DETECTION

(71) Applicants: Danny M. Sheldon, Chuluota, FL (US); Kristine A. Kushner, Chuluota, FL (US); Trent Lewis, Winter Park, FL (US); Dane J. Hurt, Orlando, FL (US)

(72) Inventors: Danny M. Sheldon, Chuluota, FL (US); Kristine A. Kushner, Chuluota, FL (US); Trent Lewis, Winter Park, FL (US); Dane J. Hurt, Orlando, FL (US)

(21) Appl. No.: 13/972,203

(22) Filed: Aug. 21, 2013

(51) Int. Cl. G01M 3/04

(52) U.S. Cl. CPC G01M 3/04
USPC 73/40.5 R

(57) ABSTRACT

Internally shielded fuel passage orifices in nozzle rocket swirler airfoils are sealed with the pressure test tool. Pinch clamps on the test tool are introduced into the fuel nozzle rocket swirler. The clamps are tightened over the airfoil orifices to plug or otherwise seal them and their fuel passages within the nozzle assembly. The nozzle assembly fuel passages are subsequently pressurized. Pressure is monitored to determine whether the nozzle is properly sealed (i.e., no pressure decay) or whether it has a leak-causing structural defect. Pressure drop in the tested component during the test cycle is indicative of a leak, in the nozzle's fuel passages, caused for example by a structural defect in the component. The test system may also be utilized in conjunction with individual rocket swirlers that are not incorporated within a complete fuel nozzle assembly.

### BACKGROUND OF THE INVENTION

1. Field of the Invention

The invention relates to pressure testing tools for gas turbine engine fuel nozzles. Fuel passage orifices in the nozzle rocket swirler airfoils are sealed with the pressure test tool. The tested nozzle rocket swirler or an entire tested fuel nozzle assembly is then pressurized. Pressure drop in the tested component during the test cycle is indicative of a leak, in the nozzle's fuel passages, caused for example by a structural defect in the component.

2. Description of the Prior Art

Industrial gas turbine engine fuel nozzles have sealed fuel flow passages terminating in orifices, to assure fuel routing to designated locations within the engine combustor at the orifice discharges. Fuel is discharged and entrained within the compressor-supplied compressed air in a controlled fashion to assure efficient combustion. Fuel flow passage leaks are detrimental to desired engine combustion performance, so the fuel nozzles have been tested for leaks after manufacture or service rebuild prior to field service use. Some past fuel design nozzles had externally-accessible orifices that could be plugged to seal fuel passages for subsequent pressure testing. After plugging the fuel orifices a source of pressurized air was affixed to the nozzle fuel supply inlet. Pressure status was monitored over time. Pressure maintenance was indicative of satisfactory nozzle fuel passage sealing. Conversely, pressure decay was indicative of one or more leaks in the nozzle fuel passages.

Newer gas turbine engine fuel nozzle designs incorporate internally shielded fuel orifices that are not readily accessible from the nozzle external periphery. Traditional pressurized air fuel passage leak detection systems could not be utilized in conjunction with the newer nozzle designs because the internally shielded fuel orifices could not be plugged with known exterior orifice plug tool designs. Thus, more expensive non-destructive evaluation methods, such as X-ray scanning, had to be utilized to test for structural defects, such as weld cracks or other voids.

Thus, a need exists in the art for a pressurized air fuel leak detection system for gas turbine nozzles having shielded fuel orifices, so as to avoid the expense of X-ray and other more expensive non-destructive evaluation methods.

### SUMMARY OF THE INVENTION

Accordingly, an object of the invention is to create a pressurized air fuel leak detection system for gas turbine nozzles having shielded fuel orifices, by plugging the shielded orifices remotely from the nozzle exterior and thereafter pressurizing the fuel passages. Monitored pressure status thus is indicative of sealed nozzle fuel supply lines if pressure is maintained, but conversely pressure decay is indicative of a structural leek in the fuel supply lines.

These and other objects are achieved by embodiments of the invention described herein. Pinch clamps are introduced into the fuel nozzle rocket swirler. The clamps are tightened over orifices to seal them and their fuel passages within the nozzle assembly. The nozzle assembly fuel passages are subsequently pressurized. Pressure is monitored to determine whether the nozzle is properly sealed (i.e., no pressure decay) or whether it has a leak-causing structural defect.

An embodiment of the invention features a leak detection pressure test tool for a gas turbine engine nozzle of the type having a rocket swirler with a mounting neck. A plurality of swirler air foils radially project outwardly from the neck, having cambered upper and lower surfaces. At least one of the airfoil surfaces defines an airfoil orifice that is circumscribed radially and axially by a generally annular can. The rocket swirler has isolated fuel distribution passages in communication with the mounting neck and the airfoil orifice. The tool comprises a mounting flange adapted for abutment proximal a rocket swirler mounting neck and annular can. At least one airfoil orifice clamp is coupled to and projecting from the mounting flange. The clamp has a pair of cooperative biased jaws that are adapted for capture of a rocket swirler airfoil there between and for sealing an airfoil orifice with a surface defined by one of the jaws when the jaws are inserted into a rocket swirler annular can by abutment of the mounting flange proximal the swirler mounting neck.

Another embodiment of the invention features a leak detection pressure test tool for a gas turbine engine nozzle of the type having a nozzle mounting flange and fuel inlets projecting from nozzle mounting flange, a rocket assembly coupled to a rocket swirler by a mounting neck, a plurality of swirler air foils radially projecting outwardly from the neck, having cambered upper and lower surfaces, at least one of airfoil surfaces of each airfoil defining an airfoil orifice that is circumscribed radially and axially by a generally annular can, the rocket swirler having isolated fuel distribution passages in communication with the mounting neck and the airfoil orifice. The tool comprises an annular split mounting flange for receipt of a rocket swirler and adjoining rocket swirler mounting neck in an open position and for circumscribing the rocket swirler and mounting neck in a closed position. The mounting flange is adapted for abutment proximal a rocket swirler mounting neck and annular can in its closed position. A plurality of airfoil orifice clamps are coupled to and projecting from the annular split mounting flange in an array. Each clamp has a pair of cooperative biased jaws that are adapted for capture of a rocket swirler airfoil there between and for sealing an airfoil orifice with a surface defined by one of the jaws when the jaws are inserted into a rocket swirler annular can by circumscribing abutment of the mounting flange proximal the swirler mounting neck.

In some embodiments of the invention at least one of the biased jaw surfaces has an elastomeric pad for sealing abutment against a corresponding airfoil orifice. In other embodiments of the invention orifice clamp comprises a clamp base coupled to the mounting flange, defining a first jaw surface; a selectively movable clamp jaw defining a second jaw surface in opposed spaced relationship with the first jaw surface; a clamp base alignment tab defining an inclined surface projecting outwardly from the clamp base or clamp jaw mating with an opposed groove inclined surface defined by the other corresponding clamp base or clamp jaw; and a tension screw coupling the clamp base and clamp jaw for biasing the first and second jaw surfaces against each other.

Yet another embodiment of the invention features a method for detecting a leak in a gas turbine engine nozzle of the type having a rocket swirler with a mounting neck, a plurality of swirler air foils radially projecting outwardly from the neck, having cambered upper and lower surfaces, one or both of the airfoil surfaces defining an airfoil orifice that is circumscribed radially and axially by a generally annular can, with the rocket swirler having isolated fuel distribution passages in communication with the mounting neck and the airfoil orifice. The method comprises providing a pressure test tool having a mounting flange adapted for abutment proximal a rocket swirler mounting neck and annular can. The pressure test tool also has at least one airfoil orifice clamp coupled to and projecting from the mounting flange, the clamp having a pair of cooperative biased jaws that are adapted for capture of an airfoil there between and for sealing an airfoil orifice with a surface defined by one of the jaws. The jaws are inserted into the a rocket swirler annular can by abutment of the mounting flange proximal the swirler mounting neck. The rocket swirler airfoil is captured between the clamp jaws. The jaws are clamped about the airfoil so that each orifice is sealed by an abutting surface defined by a corresponding jaw. All other airfoil orifices defined by the rocket swirler are sealed. Then a pressurized fluid source is coupled to the engine nozzle in communication with the rocket swirler mounting neck. Fluid pressure in the engine nozzle is monitored over a monitoring time interval with a pressure monitoring device, such as an analog or digital pressure gauge, with or without remote or automated monitoring/data recording features. A nozzle leak is indicated or identified if monitored pressure falls within the monitored time interval.

A plurality of test tools may be clamped to corresponding airfoil orifices of a multiple rocket swirler gas turbine engine nozzle while the nozzle swirlers are affixed to their respective main rockets. A pressurization system, comprising a manifold adapted for fluid-tight coupling to a nozzle cover that is in turn fluid-tight coupled to a nozzle mounting flange are substituted for the engine nozzle fuel control system and fuel inlet. The pressure gauge or other pressure monitoring device is coupled to the manifold. The pressurized fluid source is selectively coupled to the manifold by a valve interposed there between.

The objects and features of the present invention may be applied jointly or severally in any combination or sub-combination by those skilled in the art.

### BRIEF DESCRIPTION OF THE DRAWINGS

The teachings of the present invention can be readily understood by considering the following detailed description in conjunction with the accompanying drawings, in which:

FIG. 1 is a side schematic view of a fuel nozzle assembly with a plurality of rocket swirlers having internal airfoils with fuel orifices of one of the swirlers sealed by a pressure test tool embodiment of the invention;

FIG. 2 is a perspective view of the fuel nozzle assembly of FIG. 1, showing a pressure test tool embodiment of the invention sealing swirler fuel orifices;

FIG. 3 is a top perspective view of a pressure test tool embodiment of the invention;

FIG. 4 is a bottom perspective view of the pressure test tool of FIG. 3, showing radially oriented orifice clamps;

FIG. 5 is a detailed cross sectional view of an orifice clamp of FIG. 4 sealing fuel orifices within a rocket swirler airfoil;

FIG. 6 is a schematic view of a nozzle pressure test system embodiment of the invention, wherein pressure test tool clamps seal off all rocket swirler airfoil orifices, so that the entire assembled nozzle can be pressure tested; and

FIG. 7 is a schematic view of a rocket swirler pressurization assembly, wherein pressure test tool clamps seal off all airfoil orifices in a single rocket swirler that is dismounted from a fuel nozzle assembly.

To facilitate understanding, identical reference numerals have been used, where possible, to designate identical elements that are common to the figures.

### DETAILED DESCRIPTION

After considering the following description, those skilled in the art will clearly realize that the teachings of the present invention can be readily utilized fuel leak pressure test systems for industrial gas turbine fuel nozzle assemblies that have internally shielded fuel passage orifices constructed within nozzle rocket swirler airfoils. The airfoil fuel passage orifices are sealed with a pressure test tool that is part of the pressure test system. Pinch clamps on the test tool are introduced into the fuel nozzle rocket swirler from an exterior end of the swirler, such as proximal the junction between the nozzle rocket and the rocket swirler. The clamps are tightened over the airfoil orifices to plug or otherwise seal them and their fuel passages within the nozzle assembly. Advantageously a plurality of clamps are coupled to the test tool so that they can be positioned in proximity to respective swirler airfoils simultaneously. The nozzle assembly fuel passages are subsequently pressurized. Pressure is monitored to determine whether the nozzle is properly sealed (i.e., no pressure decay) or whether it has a leak-causing structural defect. Pressure drop in the tested component during the test cycle is indicative of a leak, in the nozzle's fuel passages, caused for example by a structural defect in the component. Pressure test tool clamps can be applied to all airfoil orifices within an fully assembled nozzle or an individual rocket swirler can be pressure tested. Leak-free rocket swirlers or assembled fuel nozzles can be designated for service within a gas turbine engine.

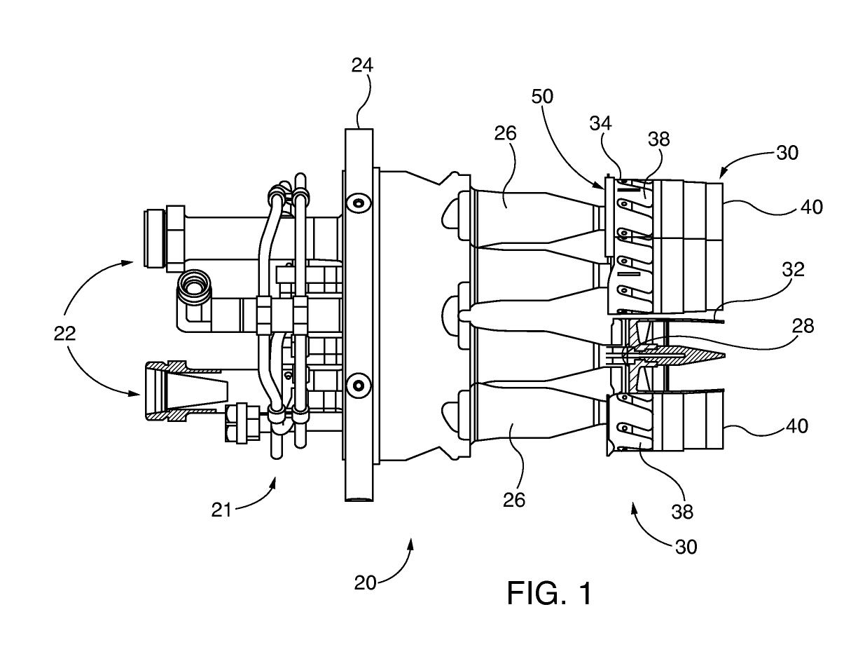

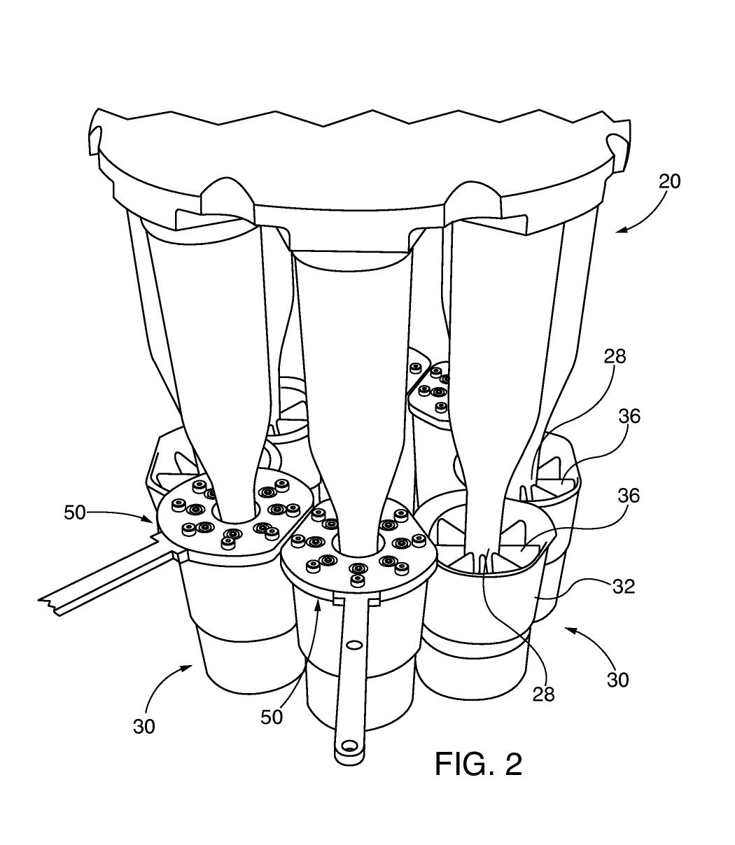

FIGS. 1 and 2 show an industrial gas turbine nozzle assembly 20, with a fuel control system 21 and fuel inlets 22 for coupling to a fuel source, such as natural gas. The nozzle assembly 20 has a mounting flange 24 for coupling to a gas turbine combustor. The nozzle assembly 20 has a plurality of circularly oriented main rocket assemblies 26, the respective necked distal ends of which are coupled to respective rocket swirlers 30 by mounting necks 28. Each rocket swirler has an annular can 32 with an upstream axial end 34. Shielded within each annular can 32 are a plurality of radially oriented airfoils 36 having cambered upper and lower airfoil surfaces that define one or more fuel orifices 38 on either or both surfaces. In FIGS. 1 and 2 both airfoil surfaces define one fuel orifice 38. The fuel orifices 38 are the terminal distal ends of sealed fuel delivery lines or passages that are arrayed within the fuel nozzle assembly 20. The fuel lines are intended to be sealed between the upstream fuel inlets 22 and the downstream terminal distal end orifices 38, so that fuel does not leak from the nozzle assembly 20. Fuel discharged from the orifices 38 is intended to be entrained within turbine compressor-supplied compressed air passing through the rocket swirlers 30 and discharged from the downstream axial swirler end 40.

In order to conduct a pressure leak test of the fuel lines and passages the fuel inlets 22 and the orifices must be plugged or otherwise sealed to isolate the fuel transport path from ambient atmosphere. As shown in FIGS. 1 and 2, the orifices 38 are not readily accessible from the swirler 30 external periphery. The swirler can 32 circumferentially shields all of the orifices. Due to the swirler 30 axial geometry, there is a relatively longer axial distance to access the orifices from the swirler can downstream end 40 than from the upstream axial end 34. However airfoil orifice 38 access from the open upstream axial end 34 of the swirler 30 is partially blocked by the rocket assembly 26.

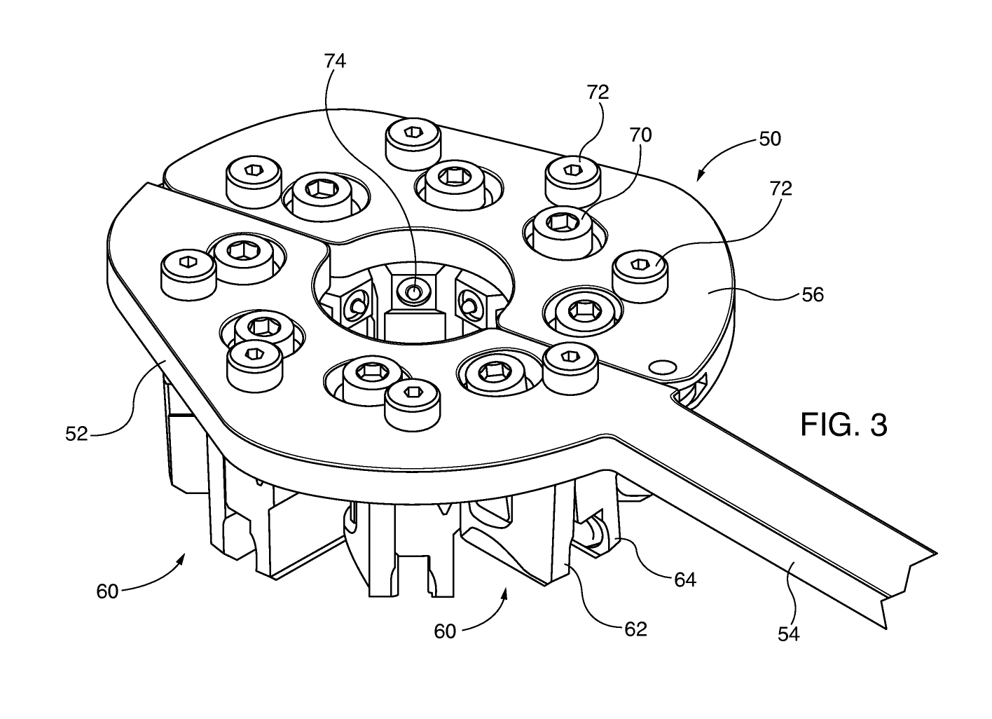

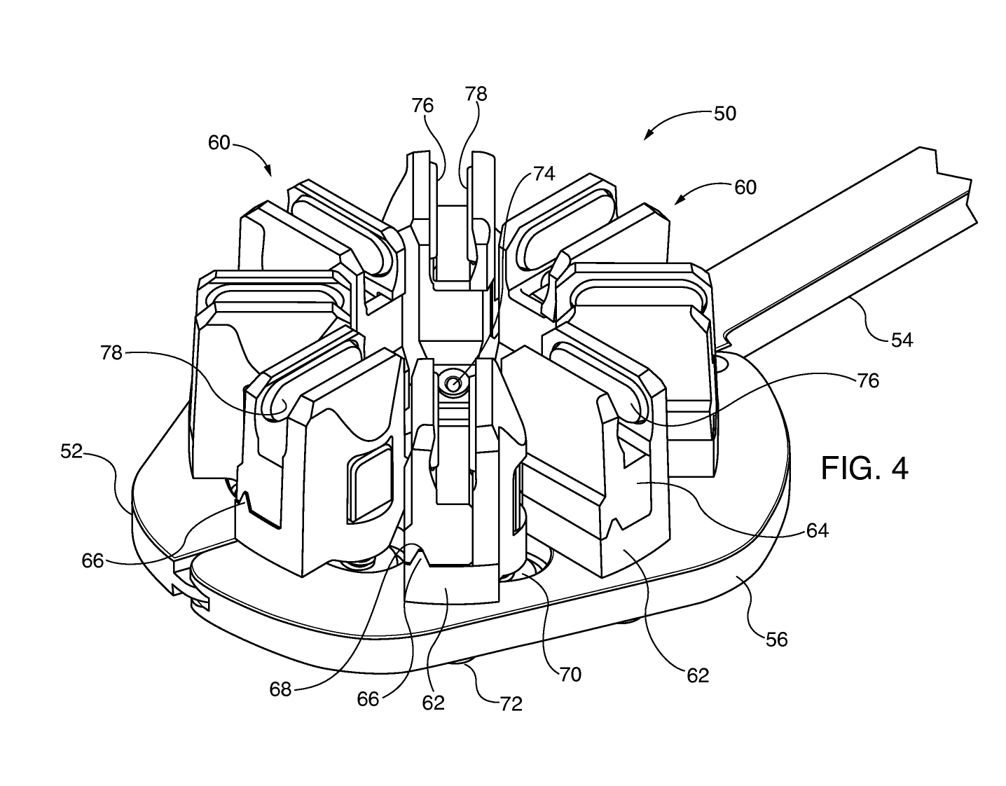

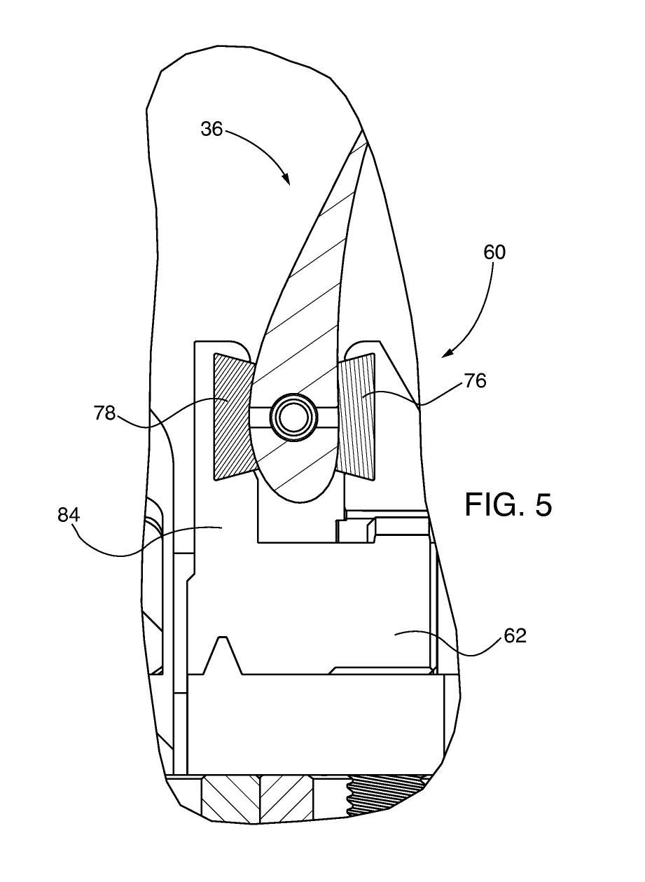

As shown in FIGS. 2-5 an embodiment of the pressure test tool 50 of the present invention is inserted into the rocket swirler upstream axial end 34 over the swirler airfoils 36. The pressure test tool 50 has first and second segmented mounting flange halves 52, 56 that are separated to circumscribe the main rocket assembly 26 proximal the main rocket assembly mounting neck 28. The first flange half 52 has a handle portion 54 for manipulation and positioning of the tool 50 about the nozzle assembly 20. The flange halves 52, 56 define arrays of clamp tension screw apertures 58 and clamp retention screw apertures 59 for coupling of a radially oriented array of airfoil orifice clamps 60. The clamps 60 project from a bottom surface of the pressure test tool 50 and are adapted to receive the corresponding respective airfoil 36 cambered upper and lower surfaces that define the airfoil orifices 38 when positioned within the rocket swirler 30.

Each clamp 60 comprises a clamp base 62 and an opposed compressive clamp jaw 64 that are coupled together by clamp tension screw 70. The clamp base 62 and clamp jaw 64 for a pair of cooperative biased jaws. The clamp base 62 is in turn affixed to its respective segmented mounting flange 52 or 56 by a clamp retention screw 72 that passes through a corresponding clamp retention screw aperture 59. The clamp jaw 64, in cooperation with the clamp base 62, is adapted for applying compressive biasing force on the captured airfoil 36 by relative sliding movement between an inclined surface of the outwardly projecting, generally vee-shaped clamp base alignment tab 66 and the corresponding inclined surface of clamp jaw alignment groove 68. As the clamp tension screw 70 (accessible from the exterior of the pressure test tool 50 via its corresponding clamp tension screw aperture 58) is tightened, elastomeric clamp base pad 76 and elastomeric clamp jaw pad 78 compress against and seal their corresponding abutting airfoil orifices 38. In this manner the fuel supply line/passages distal orifices in the swirlers 30 are effectively plugged by the pressure test tool 50. The individual swirler 30 or swirlers in an complete nozzle assembly 20 are now ready for pressure testing.

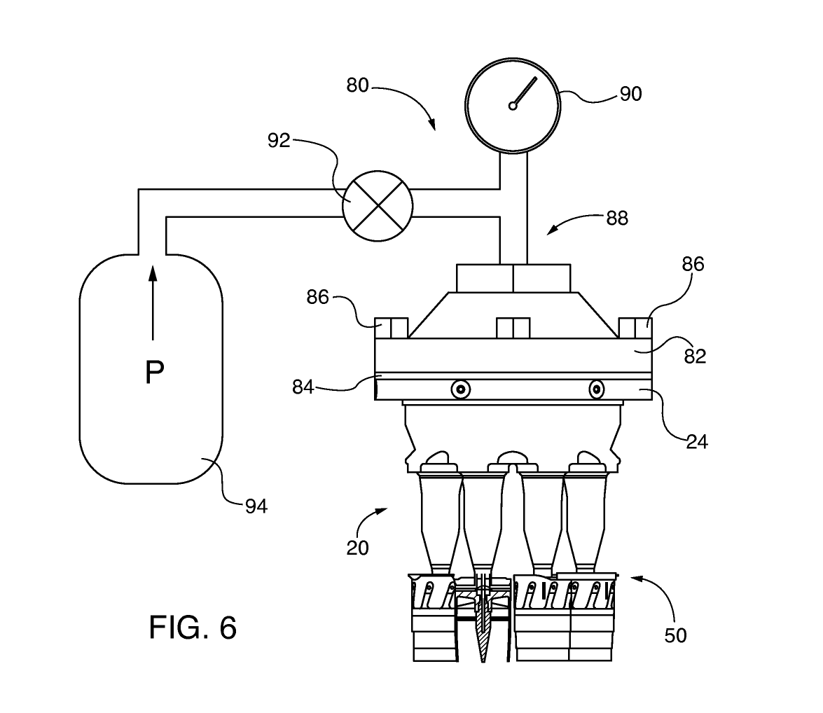

In FIG. 6 a nozzle test pressurization system 80 is coupled to a nozzle assembly 20 with its swirler airfoil orifices already plugged by the pressure test tools 50 that correspond to each individual rocket swirler 30 that forms the nozzle assembly array. Specifically the nozzle pressurization system 80 has a nozzle cover 82 and a nozzle gasket 84 that is interposed between the nozzle cover and the nozzle mounting flange 24 and tightened by cover retention screws 86. The nozzle cover 82 substitutes for the fuel control system 21 and fuel inlets 22. Pressure test manifold 88 is coupled to the nozzle cover 82 by screw threads and provides sealed communication with pressure gauge 90 or other pressure monitoring device/sensor, pressure valve 92 and a pressurized air source 94, such as a storage tank, pressure line or pressure cylinder. The entire fuel supply line/passage network from the fuel supply/mounting flange 24 end of the nozzle assembly to the plugged nozzle orifices 38 is now part of a pressurized closed system. Air pressure is introduced into the nozzle assembly 20 by opening the valve 92 to pressurize the nozzle assembly to a desired pressure level (e.g., 200-300 PSIG). Pressure level is monitored for a designated time period (e.g., 30 minutes). Any significant pressure decay greater than what might be attributable to changes in ambient air temperature or pressure is indicative of a structural leak in the nozzle assembly 20, which indicates that the nozzle assembly needs repair and is not presently suitable for field service. Conversely, constant pressure maintenance over the designated 30 minute monitoring period indicates that the nozzle assembly 20 is sealed and suitable for field service. Fluid pressure in the engine nozzle may be monitored with other pressure monitoring devices, such as an analog or digital pressure gauge or sensors with or without remote or automated monitoring/data recording features.

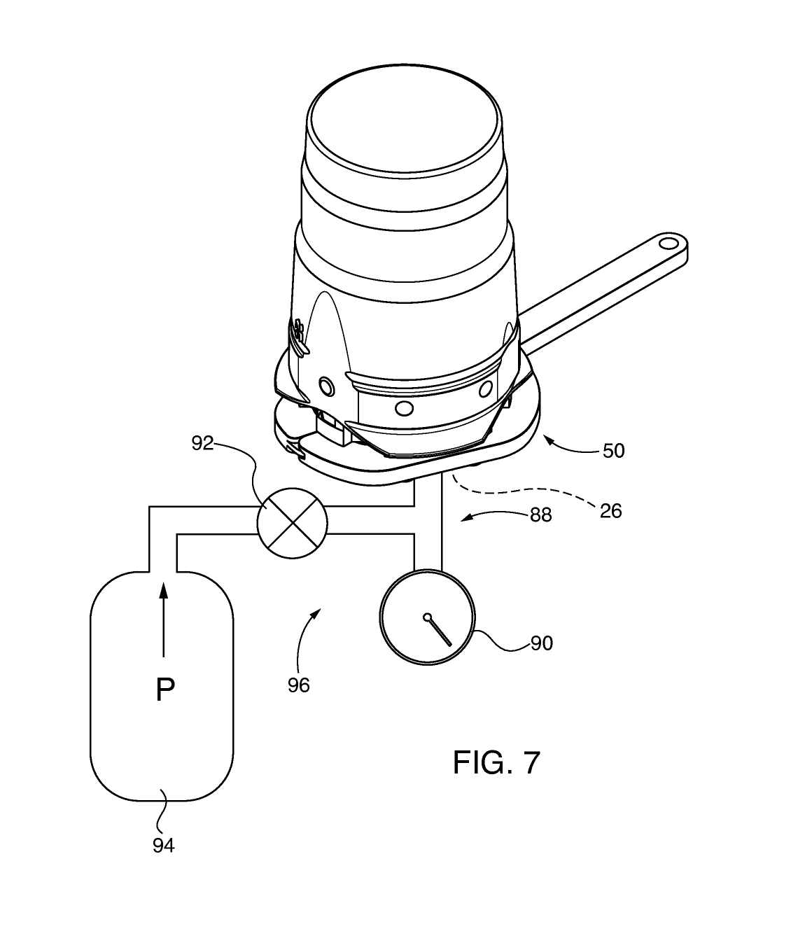

The pressure test tool 50 may be used to test an individual rocket swirler 30 that is not attached to a nozzle assembly, as shown in FIG. 7. In this embodiment the swirler test pressurization system 96 has a manifold 88 that is directly coupled to the threaded main rocket assembly mounting neck 28. The pressure gauge 90, pressure valve 92 and pressurized air source 94 are operated in a similar fashion as described with respect to the nozzle test pressurization assembly 80 of FIG. 6.

The modular pressure test tool 50 embodiments of the invention facilitate reliable plug sealing of fuel delivery airfoil orifices in rocket swirlers, so that individual swirlers or complete fuel nozzle assemblies of gas turbine engines can be pressure tested without resorting to more expensive X-ray or other non-destructive evaluation leak inspection systems.

Although various embodiments that incorporate the teachings of the present invention have been shown and described in detail herein, those skilled in the art can readily devise many other varied embodiments that still incorporate these teachings. The invention is not limited in its application to the exemplary embodiment details of construction and the arrangement of components set forth in the description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass direct and indirect mountings, connections, supports, and couplings. Further, “connected” and “coupled” are not restricted to physical or mechanical connections or couplings.

What is claimed is:

1. A leak detection pressure test tool for a gas turbine engine nozzle of the type having a rocket swirler with a mounting neck, a plurality of swirler air foils radially projecting outwardly from the neck, having cambered upper and lower surfaces, at least one of the airfoil surfaces defining an airfoil orifice that is circumscribed radially and axially by a generally annular can, the rocket swirler having isolated fuel distribution passages in communication with the mounting neck and the airfoil orifice, the tool comprising:
a mounting flange adapted for abutment proximal a rocket swirler mounting neck and annular can; and
at least one airfoil orifice clamp coupled to and projecting from the mounting flange, the clamp having a pair of cooperative biased jaws that are adapted for capture of an airfoil there between and for sealing an airfoil orifice with a surface defined by one of the jaws when the jaws are inserted into a rocket swirler annular can by abutment of the mounting flange proximal the swirler mounting neck.

2. The tool of claim 1, the mounting flange comprising an annular split mounting flange for receipt of a rocket swirler mounting neck in an open position and for circumscribing the mounting neck in a closed position.

3. The tool of claim 2 comprising a plurality of airfoil orifice clamps coupled to the annular split mounting flange in an array, for capturing a corresponding respective airfoil therein.

4. The tool of claim 3, at least one of the biased jaw surfaces having an elastomeric pad for sealing abutment against a corresponding airfoil orifice.

5. The tool of claim 1, at least one of the biased jaw surfaces having an elastomeric pad for sealing abutment against a corresponding airfoil orifice.

6. The tool of claim 1, the airfoil orifice clamp comprising:
a clamp base coupled to the mounting flange, defining a first jaw surface;
a selectively movable clamp jaw defining a second jaw surface in opposed spaced relationship with the first jaw surface;
a clamp base alignment tab defining an inclined surface projecting outwardly from the clamp base or clamp jaw mating with an opposed groove inclined surface defined by the other corresponding clamp base or clamp jaw; and
a tension screw coupling the clamp base and clamp jaw for biasing the first and second jaw surfaces against each other.

7. The tool of claim 6, each jaw surface having an elastomeric pad for sealing abutment against a corresponding airfoil orifice.

8. The tool of claim 1, each jaw surface having an elastomeric pad for sealing abutment against a corresponding airfoil orifice.

9. The tool of claim 1 incorporated in a gas turbine engine nozzle swirler pressurization system further comprising:
a manifold adapted for fluid-tight coupling to a rocket swirler mounting neck;
a pressure monitoring device coupled to the manifold; and
a pressurized fluid source selectively coupled to the manifold by a valve interposed there between.

10. The tool of claim 1 incorporated in a gas turbine engine nozzle pressurization system further comprising:
the mounting flange comprising an annular split mounting flange for receipt of a rocket swirler and adjoining rocket swirler mounting neck in an open position and for circumscribing the rocket swirler and mounting neck in a closed position;
a manifold adapted for fluid-tight coupling to a nozzle cover that is in turn fluid-tight coupled to a nozzle mounting flange;
a pressure monitoring device coupled to the manifold; and
a pressurized fluid source selectively coupled to the manifold by a valve interposed there between.

11. A leak detection pressure test tool for a gas turbine engine nozzle of the type having a nozzle mounting flange and fuel inlets projecting from nozzle mounting flange, a rocket assembly coupled to a rocket swirler by a mounting neck, a plurality of swirler air foils radially projecting outwardly from the neck, having cambered upper and lower surfaces, at least one of airfoil surfaces of each airfoil defining an airfoil orifice that is circumscribed radially and axially by a generally annular can, the rocket swirler having isolated fuel distribution passages in communication with the mounting neck and the airfoil orifice, the tool comprising:
an annular split mounting flange for receipt of a rocket swirler and adjoining rocket swirler mounting neck in an open position and for circumscribing the rocket swirler and mounting neck in a closed position; the mounting flange adapted for abutment proximal a rocket swirler mounting neck and annular can in its closed position; and
a plurality of airfoil orifice clamps coupled to and projecting from the annular split mounting flange in an array, each clamp having a pair of cooperative biased jaws that are adapted for capture of an airfoil there between and for sealing an airfoil orifice with a surface defined by one of the jaws when the jaws are inserted into a rocket swirler annular can by circumscribing abutment of the mounting flange proximal the swirler mounting neck.

12. The tool of claim 11, each respective airfoil orifice clamp comprising:
a clamp base coupled to the mounting flange, defining a first jaw surface;
a selectively movable clamp jaw defining a second jaw surface in opposed spaced relationship with the first jaw surface;
a clamp base alignment tab defining an inclined surface projecting outwardly from the clamp base or clamp jaw mating with an opposed groove inclined surface defined by the other corresponding clamp base or clamp jaw; and
a tension screw coupling the clamp base and clamp jaw for biasing the first and second jaw surfaces against each other.

13. The tool of claim 12, at least one of the biased jaw surfaces in at least one of the airfoil orifice clamps having an elastomeric pad for sealing abutment against a corresponding airfoil orifice.

14. The tool of claim 12 incorporated in a gas turbine fuel nozzle pressurization system further comprising:
a manifold adapted for fluid-tight coupling to a nozzle cover that is in turn fluid-tight coupled to a nozzle mounting flange;
a pressure monitoring device coupled to the manifold; and
a pressurized fluid source selectively coupled to the manifold by a valve interposed there between.

15. The tool of claim 11 incorporated in a gas turbine fuel nozzle pressurization system further comprising:
a manifold adapted for fluid-tight coupling to a nozzle cover that is in turn fluid-tight coupled to a nozzle mounting flange;
a pressure monitoring device coupled to the manifold; and
a pressurized fluid source selectively coupled to the manifold by a valve interposed there between.

16. A method for detecting a leak in a gas turbine engine nozzle of the type having a rocket swirler with a mounting neck, a plurality of swirler air foils radially projecting outwardly from the neck, having cambered upper and lower surfaces, one or both of the airfoil surfaces defining an airfoil orifice that is circumscribed radially and axially by a generally annular can, the rocket swirler having isolated fuel distribution passages in communication with the mounting neck and the airfoil orifice, the method comprising:
providing a pressure test tool having:
a mounting flange adapted for abutment proximal a rocket swirler mounting neck and annular can; and
at least one airfoil orifice clamp coupled to and projecting from the mounting flange, the clamp having a pair of cooperative biased jaws that are adapted for capture of an airfoil there between and for sealing an airfoil orifice with a surface defined by one of the jaws;
inserting the jaws into the a rocket swirler annular can by abutment of the mounting flange proximal the swirler mounting neck;
capturing a rocket swirler airfoil between the clamp jaws;
clamping the jaws about the airfoil so that each orifice is sealed by an abutting surface defined by a corresponding jaw;
sealing all other airfoil orifices defined by the rocket swirler;
coupling a pressurized fluid source to the engine nozzle in communication with the rocket swirler mounting neck;
monitoring fluid pressure in the engine nozzle with a pressure monitoring device over a monitoring time interval; and
identifying a nozzle leak if monitored pressure falls within the monitored time interval.

17. The method of claim 16, further comprising:
providing a pressure test tool having:
a flange having an annular split mounting flange for receipt of a rocket swirler mounting neck in an open position and for circumscribing the mounting neck in a closed position; and
a plurality of airfoil orifice clamps coupled to the annular split mounting flange in an array, for capturing a corresponding respective rocket swirler airfoil therein
opening the split mounting flange and inserting a rocket swirler mounting neck therein;
closing the annular split mounting flange and circumscribing the mounting neck therein;
inserting the airfoil clamps into the rocket swirler and capturing each corresponding airfoil therein by abutting the mounting flange proximal a rocket swirler mounting neck and annular can; and
tightening the respective clamps so that each respective orifice is sealed by an abutting surface defined by a corresponding jaw.

18. The method of claim 17, the engine nozzle having a fuel inlet, a fuel control system, a plurality of circularly oriented main rocket assemblies in communication with the fuel inlet and fuel control system, respective necked distal ends of each main rocket assembly being coupled to a corresponding mounting neck of rocket swirler, the method further comprising:
providing a pressure test tool for each respective rocket swirler;
opening the split mounting flange of each respective pressure test tool and inserting a corresponding rocket swirler mounting neck therein;
closing the annular split mounting flange of each respective pressure test tool and circumscribing the corresponding mounting neck therein;
inserting the plurality of pressure test tool jaws of each respective pressure test tool into its corresponding rocket swirler annular can by abutment of the mounting flange proximal the swirler mounting neck;
capturing a corresponding rocket swirler airfoil between each respective set of clamp jaws;
clamping the respective jaws about its respective airfoil so that the orifice or orifices are sealed by an abutting surface defined by a corresponding jaw;
sealing all other airfoil orifices defined by the rocket swirlers;
coupling a pressurized fluid source to the engine nozzle in communication with fuel passages that are in turn in communication with the fuel inlet and the mounting neck of each respective rocket swirler;
monitoring fluid pressure in the engine nozzle with a pressure monitoring device over a monitoring time interval; and
identifying a nozzle leak if monitored pressure falls within the monitored time interval.

19. The method of claim 16, the engine nozzle having a fuel inlet, a fuel control system, a plurality of circularly oriented main rocket assemblies in communication with the fuel inlet and fuel control system, respective necked distal ends of each main rocket assembly being coupled to a corresponding mounting neck of rocket swirler, the method further comprising:
providing a pressure test tool for each respective rocket swirler;
inserting the pressure test tool jaws of each respective pressure test tool into its corresponding rocket swirler annular can by abutment of the mounting flange proximal the swirler mounting neck;
capturing a rocket swirler airfoil between each respective set of clamp jaws;
clamping the respective jaws about its respective airfoil so that the orifice is sealed by an abutting surface defined by a corresponding jaw;
sealing all other airfoil orifices defined by the rocket swirlers;
coupling a pressurized fluid source to the engine nozzle in communication fuel passages that are in communication with the fuel inlet and the mounting neck of each respective rocket swirler;
monitoring fluid pressure in the engine nozzle with a pressure monitoring device over a monitoring time interval; and
identifying a nozzle leak if monitored pressure falls within the monitored time interval.

20. The method of claim 19, further comprising coupling the pressurized fluid source to the engine nozzle by a fuel nozzle pressurization system further comprising:
removing the fuel inlet and fuel control system from an engine nozzle mounting flange that is in communication with the main rocket assemblies;
coupling a nozzle cover to the engine nozzle flange in fluid tight communication with the main rocket assemblies, that substitutes for the fuel inlet and fuel control system;
fluid-tight coupling a manifold to nozzle cover;
coupling the pressure monitoring device to the manifold; and
coupling the pressurized fluid source and the valve to the manifold.
